(19) United States
(12) Patent Application Publication
(10) Pub. No.: US 2012/0063169 A1
(43) Pub. Date: Mar. 15, 2012

(54) Edge lighting for a capacitive sensing device

(76) Inventors: Jameel Abdul Ahed, Cape Coral, FL (US); Siddhartha Eluppai Srivatsan, Cape Coral, FL (US)

(21) Appl. No.: 13/135,318

(22) Filed: Jun. 30, 2011

Related U.S. Application Data
(60) Provisional application No. 61/398,756, filed on Jun. 30, 2010.
(60) Provisional application No. 61/404,460, filed on Oct. 4, 2010.

(51) Int. Cl. F21V 8/00

(52) U.S. Cl. 362/611

(57) ABSTRACT

An edge lighting system for a capacitive sensing device can include a substrate, made from an at least partially transparent material, having top and bottom surfaces, and having at least one edge; a light source, disposed adjacent to a first edge of the substrate, and being adapted to emit light waves into the substrate through the first edge; and an image etched into one of the top and bottom surfaces. At least a portion of the light waves within the substrate can travel out of at least a portion of the image so as to at least partially illuminate the image.

### CROSS-REFERENCE TO RELATED DOCUMENTS

This document claims the priority benefit, and incorporates by reference in their entireties, the following: U.S. Provisional Application Ser. No. 61/398,756, entitled “Edge Lighting in Capacitive Touch Environment” and filed on Jun. 30, 2010 by Ahed et al.; and U.S. Provisional Application Ser. No. 61/404,460, entitled “User Interface Lighting System and Method” and filed on Oct. 4, 2010 by Ahed.

### BACKGROUND OF THE INVENTION

User interfaces can be adapted to receive input commands from users via input elements, such as buttons, switches, and other input elements. Technological advances have seen the incorporation of capacitive, surface capacitive, resistive, acoustic wave, infra-red, and inductive technologies applied to user interfaces, and have replaced prior membrane-based and mechanical technologies. A user interface can include lighting elements to illuminate input and output elements.

### SUMMARY OF THE INVENTION

It is, therefore, an object of the present invention to provide edge lighting for a capacitive sensing device.

In an exemplary embodiment of the present invention, an edge lighting system for a capacitive sensing device can include a substrate, a light source, and an image.

In an exemplary aspect of the present invention, the substrate can be made from an at least partially transparent material, can have a top and bottom surfaces, and can have at least one edge.

In another exemplary aspect of the present invention, a light source can be disposed adjacent to a first edge of said substrate, and can be adapted to emit light waves into the substrate through the first edge.

In a further exemplary aspect of the invention, an image can be etched into one of the top and bottom surfaces, such that at least a portion of the light waves within the substrate can travel out of at least a portion of the image so as to at least partially illuminate the etched image.

The following are yet further exemplary aspects of the present invention: the substrate can be at least partially translucent; the first edge can be within a continuous area of the substrate; the first edge can be a terminal edge of the substrate; the first edge can be connected to a terminal edge of the substrate; the first edge can be shaped so as to be one of flat, concave, convex, and irregular; the first edge can have an angle between 1° and 180° relative to one of the top and bottom surfaces; one or more edges of the substrate can be at least partially sealed so as to prevent at least a portion of the light waves from penetrating the one or more edges; the light source can be adapted to mount to the substrate; the light source can be adapted to mount to a Printed Circuit Board; the light source can be a Light Emitting Diode; the substrate can be disposed adjacent to a capacitively monitored area of the capacitive sensing device; the substrate can be disposed within a capacitively monitored area of the capacitive sending device; the image can include a picture; or the image can include a symbol.

### BRIEF DESCRIPTION OF THE DRAWINGS

The present invention is illustrated by way of example, and not in limitation, in the figures of the accompanying drawings, in which:

FIG. 1 illustrates, from a top-view, an exemplary substrate having a square shape, edges, and an image etched into the substrate.

FIG. 2 illustrates, from a side-view, an exemplary substrate having a measurable width and edges.

FIG. 3 illustrates, from a top-view, an exemplary substrate having exemplary notches and light sources.

FIG. 4 illustrates, from a side-view, an exemplary substrate being disposed adjacent to a Printed Circuit Board with a surface mounted, 90° Light Emitting Diode.

### DETAILED DESCRIPTION OF THE INVENTION

The present invention provides a novel method and system for edge lighting for a capacitive sensing device.

According to one exemplary embodiment of the present invention, an edge lighting system for a capacitive sensing device can include a substrate, made from an at least partially transparent material, having top and bottom surfaces, and having at least one edge; a light source, disposed adjacent to a first edge of said substrate, and being adapted to emit light waves into said substrate through the first edge; and an image etched into one of the top and bottom surfaces; where at least a portion of the light waves within the substrate can travel out of at least a portion of said image so as to at least partially illuminate the etched image.

In an exemplary aspect of the present invention, a substrate can include one or more layers of an at least partially transparent material (referred to herein as a “substrate”) disposed over one or more capacitive touch mechanisms that detect a change in capacitance when a user's body (e.g., a user's finger) or an object is in close proximity to the mechanism. In another perspective, a change in capacitance can arise from the presence of a conductor or an object that has a dielectric that is different than air or the environment of the monitored area.

In another exemplary aspect, a substrate can act, inter alia, as a light pipe, which is further described herein. For example, and not in limitation, a substrate can be formed from one or more at least partially clear materials, such as, for example and not in limitation, plastic, glass, crystal, and acrylic.

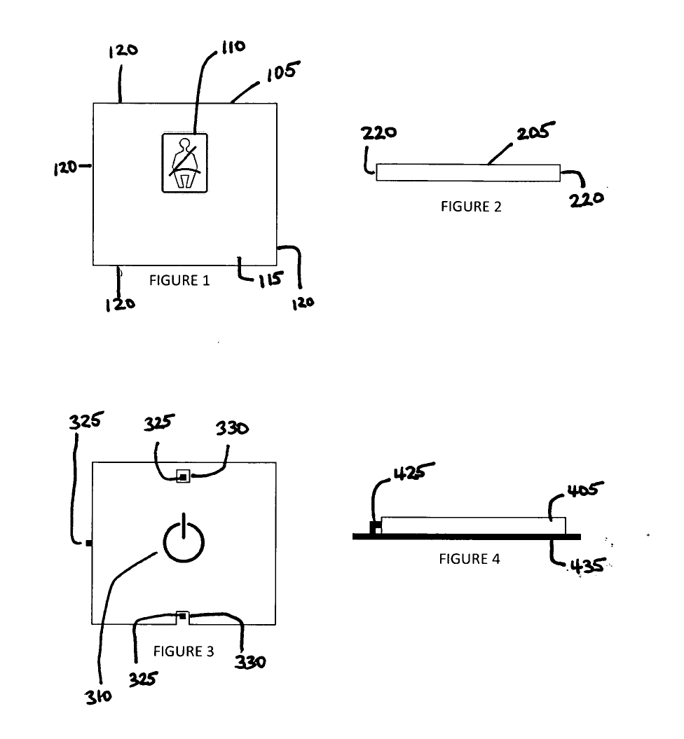

FIG. 1 illustrates a top-perspective of an exemplary substrate 105 having an image 110 etched into a top surface 115 of the substrate. As can be seen, substrate 105 can be provided with a square shape, which provides four edges 120. However, it should be noted that substrate 105 is not limited to having a square shape, as it can be provided in any desired shape that is functionally consistent with the present invention, such as, for example and not in limitation, circular, rectangular, square, oblong, and even asymmetric.

FIG. 2 illustrates a side-view perspective of an exemplary embodiment of the present invention, in which substrate 205 can include a top surface 215 (facing away from a capacitive mechanism [not shown]), a bottom surface 216 (facing towards a capacitive touch mechanism), and edges 220. As can be seen, substrate 205 has a measurable thickness, which can be constant or variable along a span of the substrate. For example, and not in limitation, substrate 205 can have a thickness of about 0.5″.

As further illustrated in FIG. 2, edges 220 can be flat between top and bottom surfaces 215, 216, and can be at an angle of about 90° between the top and bottom surfaces. However, it should be noted that edges 220 are necessarily limited to such shapes or angles. Thus, edges 220 can be provided in various angles and with various shapes to the extent desired, as long as functionally consistent with the present invention. For example and not in limitation, edge 220 can be flat, concave, convex, or even irregular; and/or can be at various angles relative to top and/or bottom surface 215, 216, such as 23°, 45°, 90°, etc.

In another exemplary aspect of the present invention, one or more light sources can be provided for generating light waves. Exemplary light sources include, but are not limited to, a Light Emitting Diode (“LED”), an incandescent light source, a florescent light source, a halogen light source, etc.

As illustrated in FIG. 3, a light source 325 can be disposed at an edge 320 to provide light waves (not shown) that are directed into the substrate from the edge. The light waves can travel through substrate 305 in a relatively straight direction and escape at other edges. Notably, substrate 305 acts as a light pipe for the light waves, which are bounded by the top and bottom surfaces. As further illustrated in FIG. 3, an edge 320 can be provided within a continuous area of substrate 305 by providing a “notch” or cut-out area 330. As illustrated, a slot 330 can be provided within a substrate 305 such that sufficient space is provided for light source 325 to be disposed therein.

According to yet another exemplary aspect, one or more interface images (which can be one or more pictures and/or symbols) can be etched (or scratched) into the top and/or bottom surfaces of the substrate. With a substrate disposed above a capacitive sensing device, such images can be aligned with capacitively monitored areas so as to provide activation areas. For example, when a user places their finger on or near a particular image, the capacitive touch mechanism can detect the change in capacitance and therefore construe such change as a user's intent to initiate a logical state associated with that image.

Further, images can be etched into the top and/or bottom surfaces in any manner desired, such as with a drill, laser, etc. By using a laser, significantly detailed images can be provided for a clear, finished look, such as providing highly detailed patters with various shading characteristics and depths. Etching depths can be constant or variable. Etchings on the top surface can be physically detected by a user, which can be desirable for those being sight-impaired. Etchings on the bottom surface can provide images that will resist debris or other contaminants (such as dirt, skin, oils, etc.) from accumulating within etches over time and use, which may adversely affect capacitance measurement. As illustrated in FIGS. 1 and 3, an image 140, 340 can convey functional information.

Notably, etched images can be relatively difficult to be visually perceived by a user. Further, in dimly or brightly lit environments, visual perception can be further impaired.

In yet another exemplary aspect of the present invention, an image etched into a substrate can provide a means for light waves to escape via the etchings, which can illuminate the image. Thus, when a light source disposed at an edge is activated, images etched into the top and/or bottom surfaces of a substrate can be illuminated and easily seen by a user.

As the number of etched images increases, differing levels of illumination for different images can occur. Therefore, in still yet another exemplary aspect of the present invention, images along a light wave path can be etched with different depths and/or density (both of which can affect how much light passes through etchings) to achieve a balanced (or if so desired, an imbalanced level) level of lighting.

FIG. 4 illustrates another exemplary aspect of the present invention, in which a substrate 405 can be disposed adjacent to a Printed Circuit Board 435 (“PCB”). Further, a light source 425, such as a surface-mounted 90° LED) can also be disposed on PCB 435. This exemplary configuration provides a highly compact and efficient system when mounted to a substrate. Notably, mounted light sources can be positioned at one or more particular edges in such a configuration.

In another exemplary aspect, edges of the substrate can “sealed” with reflective or light absorbing material. To increase overall brightness, reflective material, such as tape, paint, etc., can be applied to edges other than those providing a window for a light source. Further, combinations of light-absorbing and reflective materials can be applied to selectively manipulate light within the substrate to provide different lighting effects. And naturally, various colored light sources can be utilized for visually appealing effects. And further, light filtering materials can be applied to modify the color of light waves that escape through etchings.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention.

Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. An edge lighting system for a capacitive sensing device, the system comprising:
a substrate, made from an at least partially transparent material, having top and bottom surfaces, and having at least one edge;
a light source, disposed adjacent to a first edge of said substrate, and being adapted to emit light waves into said substrate through the first edge; and
an image etched into one of the top and bottom surfaces;
wherein at least a portion of the light waves within the substrate can travel out of at least a portion of said image so as to at least partially illuminate said image.

2. The edge lighting system of claim 1, wherein said substrate is at least partially translucent.

3. The edge lighting system of claim 1, wherein the first edge is within a continuous area of said substrate.

4. The edge lighting system of claim 1, wherein the first edge is a terminal edge of said substrate.

5. The edge lighting system of claim 1, wherein the first edge is connected to a terminal edge of said substrate.

6. The edge lighting system of claim 1, wherein the first edge is shaped so as to be one of flat, concave, convex, and irregular.

7. The edge lighting system of claim 1, wherein the first edge has an angle between 1° and 180° relative to one of the top and bottom surfaces.

8. The edge lighting system of claim 1, wherein one or more edges of said substrate are at least partially sealed so as to prevent at least a portion of the light waves from penetrating the one or more edges.

9. The edge lighting system of claim 1, where said light source is adapted to mount to said substrate.

10. The edge lighting system of claim 1, wherein said light source is adapted to mount to a Printed Circuit Board.

11. The edge lighting system of claim 1, wherein said light source is a Light Emitting Diode.

12. The edge lighting system of claim 1, wherein said substrate is disposed adjacent to a capacitively monitored area of the capacitive sensing device.

13. The edge lighting system of claim 1, wherein said substrate is disposed within a capacitively monitored area of the capacitive sending device.

14. The edge lighting system of claim 1, wherein said image includes a picture.

15. The edge lighting system of claim 1, wherein said image includes a symbol.
